(19) United States
(12) Patent Application Publication
(10) Pub. No.: US 2012/0092339 A1
(43) Pub. Date: Apr. 19, 2012

(54) MULTI-VIEW AUTOSTEREOSCOPIC DISPLAY DEVICE

(75) Inventors: Fetze Pijlman, Eindhoven (NL); Siebe Tjerk De Zwart, Eindhoven (NL); Marcellinus Petrus Carolus Michael Krijn, Eindhoven (NL)

(73) Assignee: KONINKLIJKE PHILIPS ELECTRONICS N.V., EINDHOVEN (NL)

(21) Appl. No.: 13/380,164

(22) PCT Filed: Jun. 21, 2009
(86) PCT No.: PCT/IB10/52794

§ 371 Date: Dec. 23, 2011

(30) Foreign Application Priority Data
Jun. 26, 2009 (EP) 09163872.6

(51) Int. Cl. G06T 15/00

(52) U.S. Cl. 345/419

(57) ABSTRACT

An autostereoscopic display device comprises a display panel (3) having an array of display pixel elements (5) for producing a display, the display pixel elements being arranged in rows and columns. An imaging arrangement (9) directs the output from different pixel elements to different spatial positions to enable a stereoscopic image to be viewed. The imaging arrangement comprises first and second polarization-sensitive lenticular arrays (50,52), wherein the light incident on the imaging arrangement is controllable to have one of two possible polarizations, and wherein each of the two possible polarizations gives a different 3D mode. These multiple modes can be used to increase the resolution, or increasing the number of views, or provide additional functionality to the display device.

### FIELD OF THE INVENTION

This invention relates to an autostereoscopic display device of the type that comprises a display panel having an array of display pixels for producing a display and an imaging arrangement for directing different views to different spatial positions.

### BACKGROUND OF THE INVENTION

A first example of an imaging arrangement for use in this type of display is a barrier, for example with slits that are sized and positioned in relation to the underlying pixels of the display. The viewer is able to perceive a 3D image if his/her head is at a fixed position. The barrier is positioned in front of the display panel and is designed so that light from the odd and even pixel columns is directed towards the left and right eye of the viewer.

A drawback of this type of two-view display design is that the viewer has to be at a fixed position, and can only move approximately 3 cm to the left or right. In a more preferred embodiment there are not two sub-pixel columns beneath each slit, but several. In this way, the viewer is allowed to move to the left and right and perceive a stereo image in his eyes all the time.

The barrier arrangement is simple to produce but is not light efficient. A preferred alternative is therefore to use a lens arrangement as the imaging arrangement. For example, an array of elongate lenticular elements can be provided extending parallel to one another and overlying the display pixel array, and the display pixels are observed through these lenticular elements.

The lenticular elements are provided as a sheet of elements, each of which comprises an elongate semi-cylindrical lens element. The lenticular elements (“lenticules”) extend in the column direction of the display panel, with each lenticular element overlying a respective group of two or more adjacent columns of display pixels.

In an arrangement in which, for example, each lenticule is associated with two columns of display pixels, the display pixels in each column provide a vertical slice of a respective two dimensional sub-image. The lenticular sheet directs these two slices and corresponding slices from the display pixel columns associated with the other lenticules, to the left and right eyes of a user positioned in front of the sheet, so that the user observes a single stereoscopic image. The sheet of lenticular elements thus provides a light output directing function.

In other arrangements, each lenticule is associated with a group of four or more adjacent display pixels in the row direction. Corresponding columns of display pixels in each group are arranged appropriately to provide a vertical slice from a respective two dimensional sub-image. As a user's head is moved from left to right, a series of successive, different, stereoscopic views are perceived creating, for example, a look-around impression.

The above described device provides an effective three dimensional display. However, it will be appreciated that, in order to provide stereoscopic views, there is a necessary sacrifice in the horizontal resolution of the device. This sacrifice in resolution is unacceptable for certain applications, such as the display of small text characters for viewing from short distances. For this reason, it has been proposed to provide a display device that is switchable between a two-dimensional mode and a three-dimensional (stereoscopic) mode.

One way to implement this is to provide an electrically switchable lenticular array. In the two-dimensional mode, the lenticular elements of the switchable device operate in a “pass through” mode, i.e. they act in the same way as would a planar sheet of optically transparent material. The resulting display has a high resolution, equal to the native resolution of the display panel, which is suitable for the display of small text characters from short viewing distances. The two-dimensional display mode cannot, of course, provide a stereoscopic image.

In the three-dimensional mode, the lenticular elements of the switchable device provide a light output directing function, as described above. The resulting display is capable of providing stereoscopic images, but has the inevitable resolution loss mentioned above.

For the 3D mode of operation, a major dilemma is caused by the fact that on the one hand a large number of views per angle is needed for a good 3D impression and on the other hand a small number of views is needed for a sufficiently high resolution (i.e. number of pixels) per view.

A low number of perspective views will give a shallow 3D image with little perception of depth. The larger the number of views per angle, the more the perception of 3D will resemble that of a truly 3D image such as for example a holographic image. Concentrating all the views within a small angle will give a good 3D impression but a limited viewing angle.

A major drawback of using a high number of views is that the image resolution per view is greatly reduced. The total number of available pixels has to be distributed among the views. In the case of an n-view 3D display with vertical lenticular lenses, the perceived resolution of each view along the horizontal direction will be reduced by a factor of n relative to the 2D case. In the vertical direction the resolution will remain the same. The use of a barrier or lenticular that is slanted can reduce this disparity between resolution in the horizontal and vertical direction. In that case, the resolution loss can be distributed more evenly between the horizontal and vertical directions.

Increasing the number of views thus improves the 3D impression but reduces the image resolution as perceived by the viewer. There is therefore a desire to increase the resolution per view in such an arrangement.

WO 2007/072330 discloses an approach by which an effective lateral shift between the lenticular array and the display panel is implemented, corresponding to a non-integer multiple of the pixel pitch. This enables the effective resolution to be increased in a time-sequential manner. The use of time-sequential addressing is become a more practical possibility, with frame frequencies of 100 Hz now common, and even higher frequencies being investigated. WO 2007/072330 suggests electronically controllable barrier arrangements to implement the relative shift, or switchable graded index LC lenses.

Another possibility is to use switchable prisms, arranged as LC filled elements. The light redirection implemented by the prisms can then be switched by switching the state of the LC material.

These arrangements result in a complicated imaging arrangement (i.e. the barrier arrangement or the lens arrangement), and difficulties can arise in achieving the desired switching speed for the imaging arrangement.

There is therefore a need to compensate for the loss of resolution which arises in multi-view autostereoscopic displays with an apparatus that does not add excessive complexity to the display hardware.

### SUMMARY OF THE INVENTION

It is an object of the invention to provide an autostereoscopic display that at least partly alleviates one of the aforementioned problem.

This object is achieved with a display as defined in the independent claim. The dependent claims define advantageous embodiments.

The display according to the invention enables control of the polarization of the output of the display to be used to enable selection of at least two 3D modes, i.e. the first and second 3D modes. These modes may be different modes. The multiple modes can be used to increase the resolution, by for example adding views at inter-pixel locations, or increasing the number of views, in a time sequential manner. This enables the loss of performance resulting from the generation of multiple view 3D images to be reduced. Instead, additional output functions can instead be provided, which are not only aimed at improving the resolution, but which provide additional functionality to the display device.

A polarization rotation device can be provided at the display output for controlling the polarization of the light incident on the imaging arrangement.

In one arrangement, for the first polarization of the light incident on the imaging arrangement, the first polarization-sensitive lenticular array operates in pass through mode and the second polarization-sensitive lenticular array operates in lensing mode, and for the second polarization of the light incident on the imaging arrangement, the first polarization-sensitive lenticular array operates in lensing mode and the second polarization-sensitive lenticular array operates in pass through mode.

Thus, each of the two 3D modes is generated by a respective one of the lenticular arrays.

In one example, the first and second polarization-sensitive lenticular arrays have different lens pitch. For example, one 3D mode can be for a first number of views and the other 3D mode is for a different number of views. This provides additional flexibility to the system. For example, the display can process 9 view or 15 view images.

In another example, each polarization-sensitive lenticular array is electrically switchable between its respective 3D mode and a 2D mode. This provides a 2D mode as well as the two 3D modes.

In another example, the first and second polarization-sensitive lenticular arrays have the same lens pitch, and wherein the effective lens position of one lenticular array is shifted laterally with respect to the other by an amount which is a non-integer multiple of the pitch between the pixel elements. This provides additional views at inter-pixel locations, thereby increasing the resolution at the output. By generating additional views, the image uniformity is improved and there is a reduction in banding. The amount of shift can comprise half the pitch between the individual pixel elements. However, the shift can instead comprise half the pitch between the lens elements. If each lens element width covers an odd number of pixels, this again gives shift including a half pixel, thereby enabling intermediate images to be formed, which increase the resolution.

The first and second polarization-sensitive lenticular arrays can each comprise elongate lenticular lenses, having an elongate axis offset from the column direction of the display panel. This is a known way to spread the loss of resolution between the row and column directions.

In one arrangement, the elongate axis offset for one lenticular array is different to the elongate axis offset of the other lenticular array. This enables different viewing effects to be obtained by the two lenticular arrays, for example depending on the image content.

The elongate axis of one lenticular array can be offset by less than 40 degrees from the column direction and the elongate axis of the other lenticular array can be offset by less than 40 degrees from the row direction. This enables the display to be rotatable between portrait and landscape modes, with one of the 3D modes for each. In each mode, the lenticular is closer to the vertical than the horizontal. For example the landscape mode may be associated with an angle less than 20 degrees to the vertical when the display is oriented for that mode (e.g. tan α=⅓), and the portrait mode can be associated with a larger slant angle to the vertical when the display is oriented for that mode (e.g. tan α=⅔). In this arrangement, the slant in the portrait mode is larger, so that the loss in resolution is transferred more to the columns (of which there are more in the portrait orientation). Other combinations of slant angle are possible—essentially, one slant angle is optimized for the portrait mode and the other is optimized for the landscape mode.

The display panel can comprise an array of individually addressable emissive, transmissive, refractive or diffractive display pixels, for example an LCD display.

The invention also provides a method of controlling a multi-view autostereoscopic display device comprising a display panel and an imaging arrangement for directing the display panel output to different spatial positions to enable a stereoscopic image to be viewed, the method comprising:

displaying a first image, controlling the first image to have a first polarization, and providing the first image to an imaging arrangement, which imaging arrangement comprises first and second polarization-sensitive lenticular arrays for directing the output from different pixel elements to different spatial positions to enable a plurality of stereoscopic images to be viewed from different locations, thereby providing a first 3D mode,

displaying a second image, controlling the second image to have a second polarization, and providing the second image to the imaging arrangement, thereby providing a second 3D mode.

### BRIEF DESCRIPTION OF THE DRAWINGS

An embodiment of the invention will now be described, purely by way of example, with reference to the accompanying drawings, in which:

FIG. 1 is a schematic perspective view of a known autostereoscopic display device;

FIGS. 2 and 3 are used to explain the operating principle of the lens array of the display device shown in FIG. 1;

FIG. 4 shows how a lenticular array provides different views to different spatial locations;

FIG. 5 shows a first example of imaging arrangement of the invention for a multi-view autostereoscopic display;

FIG. 6 shows a second example of imaging arrangement of the invention;

FIG. 7 is used to explain the benefit of a slanted focusing arrangement;

FIG. 8 shows a third example of imaging arrangement of the invention;

FIG. 9 shows a fourth example of imaging arrangement of the invention; and

FIG. 10 shows an autostereoscopic display device of the invention.

### DETAILED DESCRIPTION OF EMBODIMENTS

The invention provides a switchable autostereoscopic display device in which an imaging arrangement directs the output from different pixels to different spatial positions to enable a stereoscopic image to be viewed. The display is controllable between two 3D modes based on the polarization of the light provided to the imaging arrangement, in order to enable the resolution or number of images to be increased using a time multiplex approach, or to enable additional output functions to be provided.

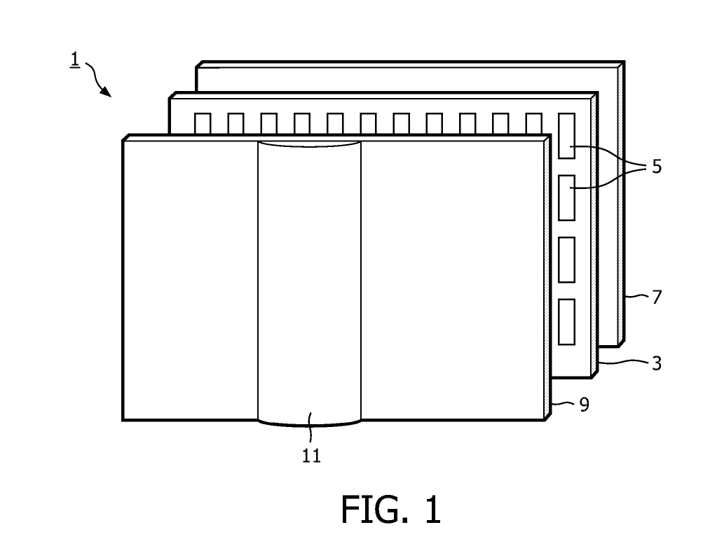

FIG. 1 is a schematic perspective view of a known direct view autostereoscopic display device 1. The known device 1 comprises a liquid crystal display panel 3 of the active matrix type that acts as a spatial light modulator to produce the display.

The display panel 3 has an orthogonal array of display pixels 5 arranged in rows and columns. For the sake of clarity, only a small number of display pixels 5 are shown in the Figure. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises a row of lenticular elements 11 extending parallel to one another, of which only one is shown with exaggerated dimensions for the sake of clarity.

The lenticular elements 11 are in the form of convex cylindrical lenses, and they act as a light output directing means to provide different images, or views, from the display panel 3 to the eyes of a user positioned in front of the display device 1.

The autostereoscopic display device 1 shown in FIG. 1 is capable of providing several different perspective views in different directions. In particular, each lenticular element 11 overlies a small group of display pixels 5 in each row. The lenticular element 11 projects each display pixel 5 of a group in a different direction, so as to form the several different views. As the user's head moves from left to right, his/her eyes will receive different ones of the several views, in turn.

It has been proposed to provide electrically switchable lens elements, as mentioned above. This enables the display to be switched between 2D and 3D modes.

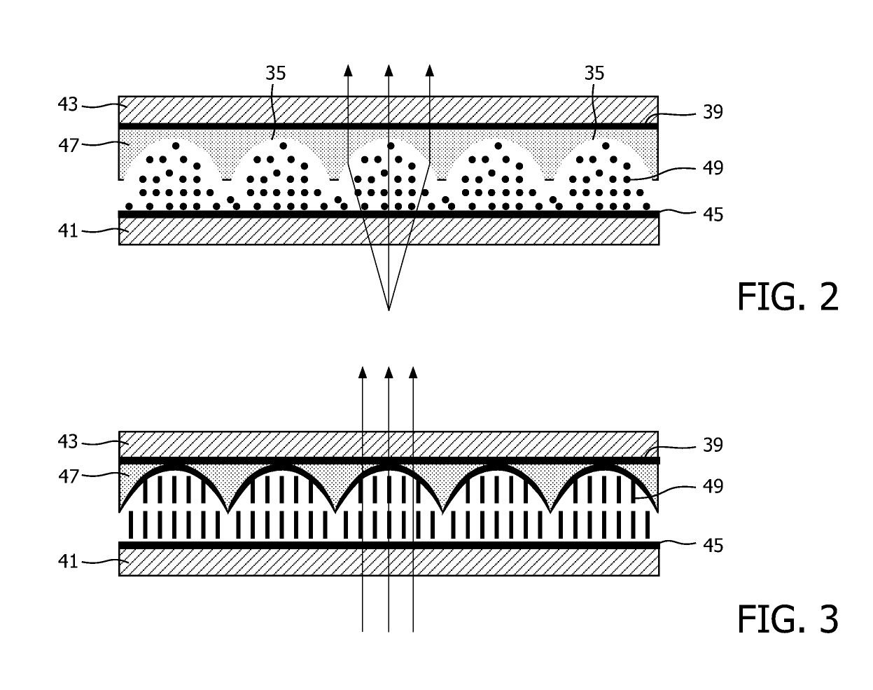

FIGS. 2 and 3 schematically show an array of electrically switchable lenticular elements 35 which can be employed in the device shown in FIG. 1. The array comprises a pair of transparent glass substrates 39, 41, with transparent electrodes 43, 45 formed of indium tin oxide (ITO) provided on their facing surfaces. An inverse lens structure 47, formed using a replication technique, is provided between the substrates 39, 41, adjacent to an upper one of the substrates 39. Liquid crystal material 49 is also provided between the substrates 39, 41, adjacent to the lower one of the substrates 41.

The inverse lens structure 47 causes the liquid crystal material 49 to assume parallel, elongate lenticular shapes, between the inverse lens structure 47 and the lower substrate 41, as shown in cross-section in FIGS. 2 and 3. Surfaces of the inverse lens structure 47 and the lower substrate 41 that are in contact with the liquid crystal material are also provided with an orientation layer (not shown) for orientating the liquid crystal material.

FIG. 2 shows the array when no electric potential is applied to the electrodes 43, 45. In this state, the refractive index of the liquid crystal material 49 for light of a particular polarization is substantially higher than that of the inverse lens array 47, and the lenticular shapes therefore provide a light output directing function, i.e. a lens action, as illustrated.

FIG. 3 shows the array when an alternating electric potential of approximately 50 to 100 volts is applied to the electrodes 43, 45. In this state, the refractive index of the liquid crystal material 49 for light of the particular polarization is substantially the same as that of the inverse lens array 47, so that the light output directing function of the lenticular shapes is cancelled, as illustrated. Thus, in this state, the array effectively acts in a “pass through” mode.

The skilled person will appreciate that a light polarizing means must be used in conjunction with the above described array, since the liquid crystal material is birefringent, with the refractive index switching only applying to light of a particular polarization. The light polarizing means may be provided as part of the display panel or the imaging arrangement of the device.

Further details of the structure and operation of arrays of switchable lenticular elements suitable for use in the display device shown in FIG. 1 can be found in U.S. Pat. No. 6,069,650.

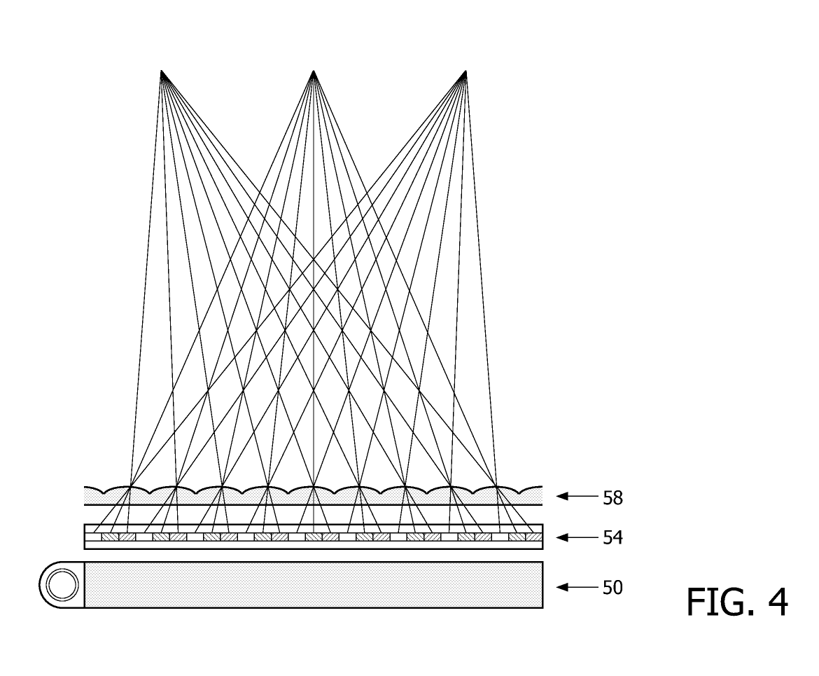

FIG. 4 shows the principle of operation of a lenticular type imaging arrangement as described above and shows the backlight 50, display device 54 such as an LCD and the lenticular array 58. FIG. 4 shows how the lenticular arrangement 58 directs different pixel outputs to different spatial locations.

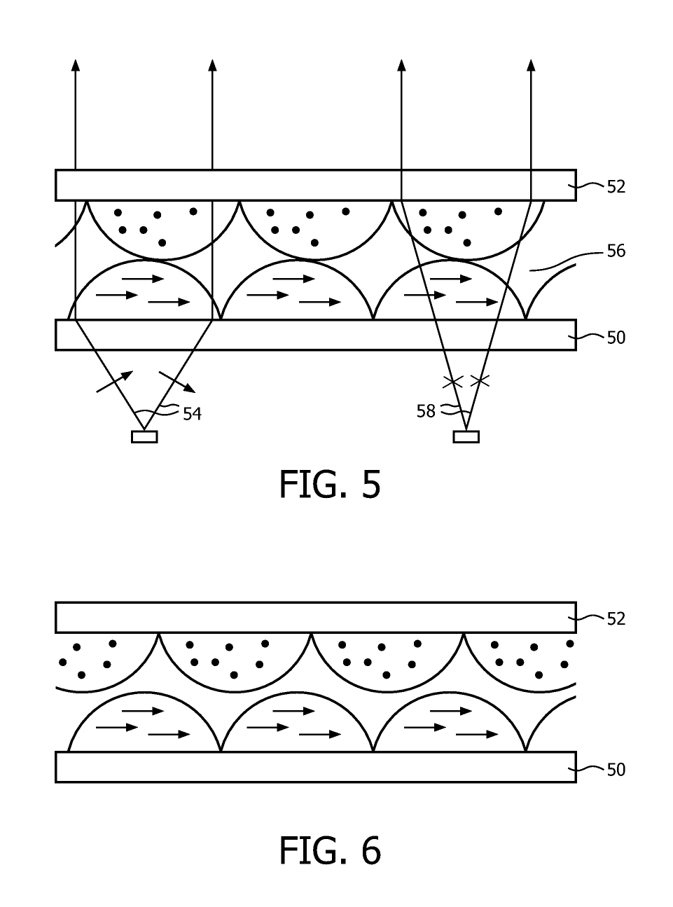

FIG. 5 shows a first example of imaging arrangement of the invention for a multi-view autostereoscopic display.

The imaging arrangement comprises first 50 and second 52 polarization-sensitive lenticular arrays. These are formed from birefringent material having an optical axis selected to be in a desired direction. The light incident on the imaging arrangement is controllable to have one of two possible polarizations.

The light rays 54 represent the light from a pixel of the display which is polarized in the row direction of the display. The first lenticular arrangement 50 has its optical axis in the same row direction, so the extra-ordinary refractive index dominates the refractive index for the incoming light (the molecule alignment axis of the LC material is generally collinear with the axis of the extra-ordinary refractive index). The material 56 between the lenticular arrays has an isotropic refractive index that corresponds to the ordinary refractive index of the lenticular arrays. Thus, a lensing function is implemented at the refractive index boundary between the material 54 and the lenses of the first array.

The second lenticular arrangement 52 has its optical axis in the column direction, so the ordinary refractive index dominates the refractive index for the incoming light. Thus, a pass through mode is implemented by the second lenticular array 52.

The light rays 58 represent the light from a pixel of the display which is polarized in the column direction of the display. For the first lenticular arrangement 50, the ordinary refractive index dominates the refractive index for the incoming light, so that there is no lensing function at the lens surface. A lensing function is implemented at the refractive index boundary between the material 54 and the lenses of the second array 52, because the extra-ordinary refractive index dominates the refractive index for the incoming light.

The optical axes of the material both lenticular arrays are in the plane of the image/display panel, but 90 degrees apart. Thus, the two different polarizations required at the display output are rotated 90 degrees with respect to each other about the normal to the display.

The invention uses the polarization of the output of the display to enable selection of two 3D modes. These 3D modes can be implemented without requiring any switching function of the lenticular arrays. They can be implemented as birefringent components, with their optical axes aligned by alignment layers.

The two 3D modes can be used to increase the resolution (for example by adding views at inter-pixel locations) or increasing the number of views, in a time sequential manner. This enables the loss of performance resulting from the generation of multiple view 3D images to be reduced. However, additional output functions can instead be provided, which are not aimed at improving the resolution, but which provided additional functionality.

The first example of FIG. 5 shows a small relative shift between the two lenticular arrays. The first and second polarization-sensitive lenticular arrays 50,52 have the same lens pitch, but the effective lens position of one lenticular array is shifted laterally with respect to the other by an amount which is a non-integer multiple of the pitch between the pixel elements. This provides additional views at inter-pixel locations, thereby increasing the resolution at the output. The amount of shift can comprises half the pitch between the pixel elements, and this is a relatively small shift compared to the lens width when the lens covers many pixel (e.g. 9). However, the shift can comprise half the pitch between the lens elements as shown in FIG. 6. If the lens elements cover an odd number of pixels, this again gives a pixel shift including a half pixel component, thereby enabling intermediate view positions to be formed.

As mentioned above, the lenticular arrays can be slanted with respect to the vertical.

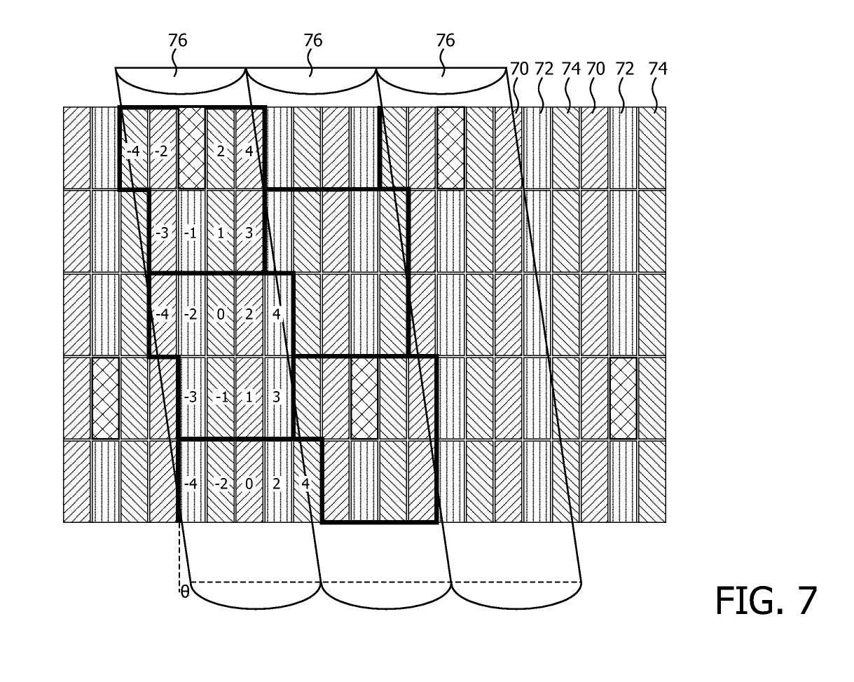

By way of example, FIG. 7 shows the sub-pixel layout of a 9-view display, and which uses slanted lenticular lenses 76. The columns are arranged as red, green and blue columns of sub pixels in sequence, respectively denoted with numbers 70, 72 and 74, and three overlying lenticular lenses 76 are shown. Each lens has a width of 4.5 sub-pixels. The numbers shown refer to the view number which the sub-pixels contribute to, with the views numbered from −4 to +4, with view 0 along the lens axis. When the aspect ratio of the sub-pixels is 1:3 as in this example (each pixel comprises a row of three sub-pixels) the optimum slant angle is tan(θ)=⅙. As a result, the perceived resolution loss per view (compared to the 2D case) is a factor of 3 in both the horizontal and vertical direction instead of a factor of 9 in the horizontal direction when the slant angle is zero. The occurrence of dark bands resulting from the black matrix is also largely suppressed.

The locations of sub-pixels of a certain color in a certain view are separated rather far apart. This is perceived as a resolution loss compared to the resolution of a regular 2D display. As an example, in FIG. 7, the locations of the green sub-pixels contributing to view zero are shown as the hatched rectangles.

By selecting between lenticulars at different positions in a time-sequential manner with respect to the LCD, the empty spaces between the hatched sub-pixels can be filled.

The first and second polarization-sensitive lenticular arrays in the device of the invention can each comprise elongate lenticular lenses, having an elongate axis offset from the column direction of the display panel.

In one arrangement, the elongate axis offset for one lenticular array is different to the elongate axis of the other lenticular array. This enables different viewing effects to be obtained by the two lenticular arrays, for example depending on the image content. Thus, the desired sharing of the loss of resolution between the row and column directions may be different for different types of image.

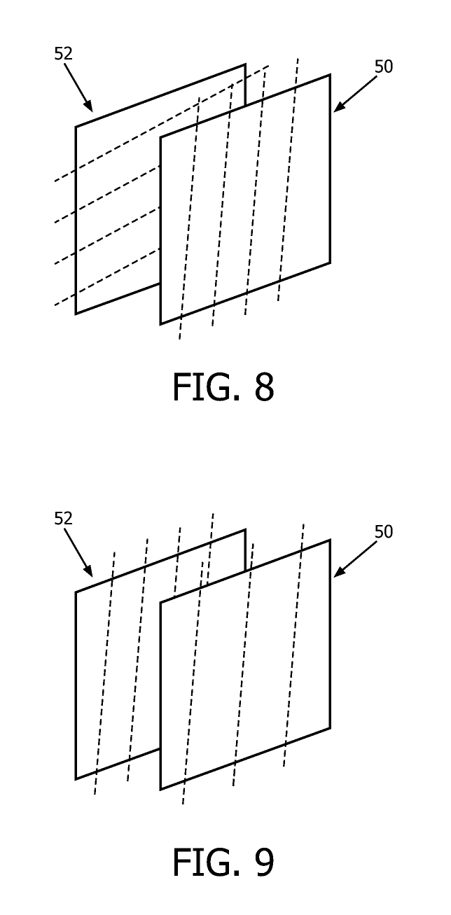

In the example shown in FIG. 8, the elongate axis (shown as dotted lines) of one lenticular array 50 can be offset by less than 40 degrees from the column direction and the elongate axis of the other lenticular array 52 can be offset by less than 40 degrees from the row direction. This enables the display to be rotatable between portrait and landscape modes, with one of the 3D modes being used for each mode. The angle chosen can be optimized for the different orientation, and they may not be the same angle. For example, the portrait mode may have an angle tan α=⅔ (where α is the angle to the vertical—which can be the row or column depending how this is defined). The landscape mode may have an angle tan α=⅓ or ⅙ (where α is the angle to the vertical—which again can be the row or column depending how this is defined). Thus, the lenses are more slanted for the portrait mode than for the landscape mode.

In the example of FIG. 9, the first and second polarization-sensitive lenticular arrays 50, 52 have different lens pitch (the central axes of the lenses again shown as dotted lines). For example, one 3D mode can be for a first number of views and the other 3D mode is for a different number of views. This provides additional flexibility to the system. For example, the display can process 9 view or 15 view images.

As mentioned above, the lenticular array does not need to be switchable to implement the switching between 3D modes. However, one or both polarization-sensitive lenticular array can be electrically switchable between its respective 3D mode and a 2D mode. This provides a 2D mode as well as the two 3D modes. This can be implemented in known manner using LC material as the birefringent material of the lenticular arrays, as explained with reference to FIGS. 2 and 3. Only one lenticular array needs to be electrically switchable so that its optical axis can be switched to be the same as the other, so that light of one polarization “sees” the same refractive index in the two lenticular arrays, and the intermediate layer 56.

The invention requires the control of the displayed image to have a desired polarization.

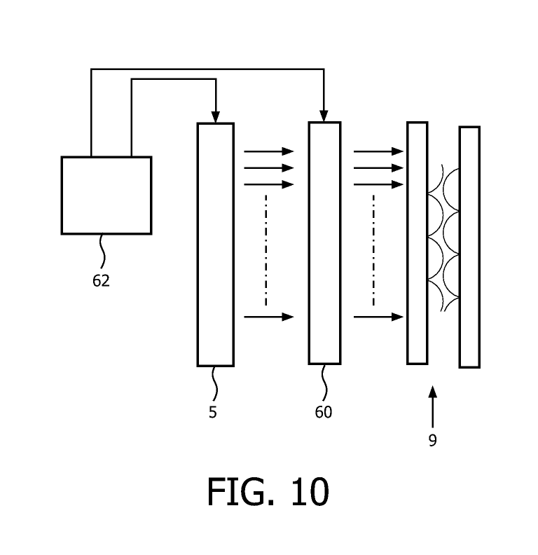

As shown in FIG. 10, this can be implemented by a polarization rotation device 60 provided at the display panel 5 and the imaging arrangement 9.

The polarization rotation device 60 is controlled by a controller 62 in synchronism with the control of the display panel output. For example, sequential images can be displayed at 100 HZ with alternation between the 3D modes, to increase the resolution, or else one 3D mode can be selected permanently while the display is in a given mode (e.g. landscape or portrait, or a mode for a particular number of views).

The polarization rotation device is for rotating the (linear) polarization about the normal to the display, and by 90 degrees. This can be implemented by a twisted nematic cell for example.

The examples above show that the two lenticular arrays can have different slant angle, pitch, slant orientation or position with respect to the display pixels. The lens shapes may also be different to provide different viewing effects.

Each lenticular lens element covers a number of pixels, to provide a multi-view system. Preferably, the width of each lens is at least equal to 4 pixels (or sub-pixels) of the display. The loss of resolution which can be reduced is particularly important for multi-view displays. The multi-view display preferably provides at least 3 autostereoscopic views (at least 4 different individual views are require for this. These would typically repeat in adjacent viewing cones at the display output. More preferably, the multi-view display can provide 4 or more autostereoscopic views.

The examples described above employ a liquid crystal display panel having, for example, a display pixel pitch in the range 50 μm to 1000 μm. However, it will be apparent to those skilled in the art that alternative types of display panel may be employed, such as organic light emitting diode (OLED) or cathode ray tube (CRT) display devices, with polarizers to control the output polarization.

The manufacture and materials used to fabricate the display device have not been described in detail, as these will be conventional and well known to those skilled in the art.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the method steps. The mere fact that certain measures are recited in mutually different dependent claims does not indicate that a combination of these measured cannot be used to advantage. A computer program for implementing the method may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A multi-view autostereoscopic display device for providing at least a first and second 3D mode, the autostereoscopic display comprising:
a display panel (3) having an array of display pixel elements (5) for producing a display, the display pixel elements being arranged in rows and columns; and
an imaging arrangement (9) which directs the output from different pixel elements to different spatial positions to enable a plurality of stereoscopic images to be viewed from different locations,
wherein the imaging arrangement comprises a first polarization-sensitive lenticular array (50) and a second (52) polarization-sensitive lenticular array, wherein the light incident on the imaging arrangement is controllable to have one of two possible polarizations, and wherein each respective one of the two possible polarizations gives one of the at least first and second 3D modes.

2. A device as claimed in claim 1, further comprising a polarization rotation device (60) for controlling the polarization of the light incident on the imaging arrangement (9).

3. A device as claimed in claim 1, wherein for the first polarization of the light incident on the imaging arrangement (9), the first polarization-sensitive lenticular array (50) operates in pass through mode and the second polarization-sensitive lenticular array (52) operates in lensing mode, and for the second polarization of the light incident on the imaging arrangement (9), the first polarization-sensitive lenticular array (50) operates in lensing mode and the second polarization-sensitive lenticular array (520 operates in pass through mode.

4. A device as claimed in claim 1, wherein the first and second polarization-sensitive lenticular arrays (50,52) have different lens pitch.

5. A device as claimed in claim 4, wherein one 3D mode is for a first number of views and the other 3D mode is for a different number of views.

6. A device as claimed in claim 5, wherein the first number of views is 9 and the second number of views is 15.

7. A device as claimed in claim 1, wherein each polarization-sensitive lenticular array (50,52) is electrically switchable between its respective 3D mode and a 2D mode.

8. A device as claimed in claim 1, wherein the first and second polarization-sensitive lenticular arrays (50,52) have the same lens pitch, and wherein the effective lens position of one lenticular array is shifted laterally with respect to the other by an amount which is a non-integer multiple of the pitch between the pixel elements.

9. A device as claimed in claim 8, the amount of shift comprises half the pitch between the pixel elements.

10. A device as claimed in claim 8, the amount of shift comprises half the pitch between the lens elements.

11. A device as claimed in claim 1, wherein the first and second polarization-sensitive lenticular arrays (50,52) each comprise elongate lenticular lenses, having an elongate axis offset from the column direction of the display panel.

12. A device as claimed in claim 11, wherein the elongate axis offset for one lenticular array is different to the elongate axis offset of the other lenticular array.

13. A device as claimed in claim 12, wherein the elongate axis of one lenticular array (50) is offset by less than 40 degrees from the column direction and the elongate axis of the other lenticular array (52) is offset by less than 40 degrees from the row direction.

14. A device as claimed in claim 1, wherein the display panel (3) comprises an array of individually addressable emissive, transmissive, refractive or diffractive display pixels.

15. A method of controlling a multi-view autostereoscopic display device for providing at least a first and second 3D mode, the autostereoscopic display comprising a display panel (3) and an imaging arrangement (9) for directing the display panel output to different spatial positions to enable a stereoscopic image to be viewed, the method comprising:
displaying a first image such that it has a first polarization, and providing the first image to an imaging arrangement (9), which imaging arrangement comprises first and second polarization-sensitive lenticular arrays (50,52) for directing the output from different pixel elements to different spatial positions to enable a plurality of stereoscopic images to be viewed from different locations, thereby providing a first 3D mode,
displaying a second image such that it has a second polarization, and providing the second image to the imaging arrangement (9), thereby providing a second 3D mode.
